(19) United States
(12) Patent Application Publication
(10) Pub. No.: US 2005/0038151 A1
(43) Pub. Date: Feb. 17, 2005

(54) Low density polyethylene articles exhibiting significantly decreased warpage at reduced cooling times

(76) Inventors: Christopher Kochanowicz, Spartanburg, SC (US); Michael Brandon Barker, Mauldin, SC (US); Xiadong E. Zhao, Moore, SC (US); Kevin Kim Kee, Singapore (SG); Richard Page, Spartanburg, SC (US)

Correspondence Address: Milliken & Company, P.O. Box 1927, Spartanburg, SC, 29304, US

(21) Appl. No.: 10/639,664

(22) Filed: Aug. 12, 2003

(51) Int. Cl. C08L 1/00

(52) U.S. Cl. 524/264; 524/284

(57) ABSTRACT

Specific low density polyethylene articles that exhibit improved physical characteristics and other benefits over previously made articles produced by less efficient means are provided. Such articles require the presence of saturated or unsaturated bicyclic dicarboxylate nucleating agents that impart increased crystallization temperatures, permit lower manufacturing cycle times, and, most importantly, cause a drastic reduction in warpage at quick cooling times during production. These resultant articles thus can be produced more efficiently with reliable low-warpage characteristics.

### FIELD OF THE INVENTION

This invention relates to specific low density polyethylene articles that exhibit improved physical characteristics and other benefits over previously made articles produced by less efficient means. Such articles require the presence of nucleating agents that impart increased crystallization temperatures, permit lower manufacturing cycle times, and, most importantly, cause a drastic reduction in warpage at quick cooling times during production. These resultant articles thus can be produced more efficiently with reliable low-warpage characteristics.

### BACKGROUND OF THE INVENTION

All U.S. patents cited below are herein entirely incorporated by reference.

Low-density polyethylene (LDPE) is a common polymer used in films and injection molded articles. Such a polymer comprises a majority of polyethylenes and exhibiting a density within the range of from about 0.910 to about 0.940 grams per cubic centimeter. The injection molded articles typically exhibit a soft feel with simultaneous low stiffness and excellent outdoor weatherability. Such polymer articles are utilized for items such as plastic lids (in order to provide effective seals), bottle caps, container articles, and the like. Unfortunately, LDPE exhibits problematic manufacturing characteristics that create undesirable costs and/or produce aesthetically and physically displeasing results. During an injection molding process, the target polymer is cooled and a next batch of polymer is transported into the mixing/plastication chamber for processing thereof. This repetitive manufacturing procedure is preferably followed via a system in which the first formed polymer is cooled extremely quickly and removed from a cooling chamber in order to permit the successive polymer article to then be formed at the same fast rate. In such a process, faster cooling permits quicker production with lower cost, in terms of time, primarily, in that greater amounts of articles can be produced at faster rates. However, in such a scenario, and in the current state of the art, LDPE articles suffer from a significant problem in that such efficient quick cooling after processing results in extreme warpage characteristics within the target finished article. As such, the only way to overcome such a problem is to permit the processed finished polymer article to cool more slowly and for a longer period of time before removal from the chamber (i.e., longer production cycles). This increase in time, although it permits the production of acceptably low warpage of LDPE articles, simultaneously increases the costs for manufacture thereof significantly. As such, there exists a need to provide a LDPE article that can be produced with much shorter cooling times (or rates) and still exhibit acceptably low warpage levels. To date, there have been no simple methods of overcoming this noticeable problem within the LDPE industry.

### Objects and Description of the Invention

The object of this invention is to provide an additive package for LDPE that can reduce warpage therein, while simultaneously permitting shorter cooling times, all while permitting much shorter manufacture cycle times required during LDPE article production.

Accordingly, the current invention encompasses a low-warpage LDPE article comprising at least one nucleator additive selected from the group consisting of saturated bicyclic dicarboxylate salts, unsaturated bicyclic dicarboxylate salts, cyclic carboxylate salts, and any mixtures thereof.

Such an inventive article exhibits extremely low warpage characteristics and increased crystallization temperatures over a non-nucleated LDPE control article, all as such an article is cooled very rapidly (between 0 to 2 seconds at 50° F., for example).

The current research investigates the ability of a LDPE resin containing inventive LDPE nucleators to control warpage while allowing faster production cycles when compared to the same LDPE without such inventive LDPE nucleators (Control). Data thus far shows the resin containing such inventive LDPE nucleators controls warpage better than the control. The increase in warpage control by the HPN-68 sample allows articles with equivalent or less warpage to be produced at a dramatically faster cycle than the control resin.

Nucleator additives are common components within thermoplastics. Specifically within polyolefins, for example, uniformity in arrangement of crystals upon crystallization is a necessity to provide an effective, durable, and versatile polyolefin article. Such additives are, as their name suggests, utilized to provide nucleation sites for crystal growth during cooling of a thermoplastic molten formulation. Generally, the presence of such nucleation sites results in a larger number of smaller crystals. As a result of the smaller crystals formed therein, clarification of the target thermoplastic may also be achieved, although excellent clarity is not always a result. The more uniform, and preferably smaller, the crystal size, the less light is scattered. In such a manner, the clarity of the thermoplastic article itself can be improved. Thus, thermoplastic nucleator compounds are very important to the thermoplastic industry in order to provide enhanced clarity, physical properties and/or faster processing.

As an example of one type of nucleator, dibenzylidene sorbitol compounds are common nucleator compounds, particularly for polypropylene end products. Compounds such as 1,3-O-2,4-bis(3,4-dimethylbenzylidene) sorbitol (hereinafter DMDBS), available from Milliken Chemical under the trade name Millad® 3988, provide excellent nucleation characteristics for target polypropylenes and other polyolefins. Other well known compounds include sodium benzoate, sodium 2,2′-methylene-bis-(4,6-di-tert-butylphenyl) phosphate (from Asahi Denka Kogyo K. K., known as NA-11), talc, and the like. Such compounds all impart high polyolefin crystallization temperatures; however, each also exhibits its own drawback for large-scale industrial applications.

Other acetals of sorbitol and xylitol are typical nucleators for polyolefins and other thermoplastics as well. Dibenzylidene sorbitol (DBS) was first disclosed in U.S. Pat. No. 4,016,118 by Hamada, et al. as an effective nucleating and clarifying agents for polyolefin. Since then, large number of acetals of sorbitol and xylitol have been disclosed. Representative US patents include: Kawai, et al., U.S. Pat. No. 4,314,039 on di(alkylbenzylidene) sorbitols; Mahaffey, Jr., U.S. Pat. No. 4,371,645 on di-acetals of sorbitol having at least one chlorine or bromine substituent; Kobayashi, et al., U.S. Pat. No. 4,532,280 on di(methyl or ethyl substituted benzylidene) sorbitol; Rekers, U.S. Pat. No. 5,049,605 on bis(3,4-dialkylbenzylidene) sorbitols including substituents forming a carbocyclic ring.

Another example of the effective nucleating agents are the metal salts of organic acids. Wijga in U.S. Pat. Nos. 3,207,735, 3,207,736, and U.S. Pat. No. 3,207,738, and Wales in U.S. Pat. Nos. 3,207,737 and 3,207,739, all patented Sep. 21, 1966, suggest that aliphatic, cycloaliphatic, and aromatic carboxylic, dicarboxylic or higher polycarboxylic acids, corresponding anhydrides and metal salts are effective nucleating agents for polyolefin. They further state that benzoic acid type compounds, in particular sodium benzoate, are the best embodiment of the nucleating agents.

Another class of nucleating agents, alluded to above, was suggested by Nakahara, et al. in U.S. Pat. No. 4,463,113, in which cyclic bis-phenol phosphates was disclosed as nucleating and clarifying agents for polyolefin resins. Kimura, et al. then suggested in U.S. Pat. No. 5,342,868 that the addition of an alkali metal carboxylate to basic polyvalent metal salt of cyclic organophosphoric ester can further improve the clarification effects of such additives. Compounds that are based upon this technologies are marketed under the trade name NA-11 and NA-21.

Such nucleators were tested in LDPE. While they provided elevated crystallization temperatures, the presence of such prior nucleators exacerbated warpage of the target injection molded LDPE articles. As such, currently, and historically, the presence of commercial nucleators within injected molded LDPE articles has been commonly avoided by the industry. Thus, investigations into other types of possible additives for such purpose were needed.

It was determined, surprisingly, that certain types of bicyclic dicarboxylate salts and cyclic dibarboxylates provide unparalleled improvements in such LDPE manufacturing procedures, and thus within finished LDPE articles themselves. Such salts are taught within U.S. Pat. No. 6,451,154 to Zhao et al., and U.S. Pat. No. 5,981,636 to Amos et al. Preferred are the saturated types of these salts due to improved crystallization temperatures and compatibility with other polyolefin additives, such as calcium stearate.

Such preferred nucleating additives include those broadly encompassed within the structure conforming to either of Formula (I) or (II) 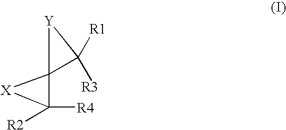
wherein X and Y are independently C₁₋₁₈ alkylene, C₂₋₁₈ alkenylene, C₃₋₁₈ cycloalkylene, C₄₋₁₈ cycloalkenylene, or arylene; wherein R₁ and R₂ are independently H, C₁₋₁₈ alkyl, or COR₅; wherein R₃ and R₄ together form -A-B-C, wherein A and C are independently a ketone, —O—, —CR₆R₇—, or —CR₆—; and wherein B is a single or double bond, or when neither A nor C is —O—, B can be —O—; R₅ is —OH, —O—C₁₋₁₈ alkyl, —O-aryl, or —NRR′; each R₆ and R₇ is independently —H, halogen, C₁₋₁₈ alkyl, C₃₋₁₈ cycloalkyl, —COR₅, —CRR′-COR₅, or NRR′; each R and R′ is independently —H, C₁₋₁₈ alkyl, C₃₋₁₈ cycloalkyl, or C₁₋₁₈ alkyl substituted by one or more —OH, halogen, —COOH, COOC₁₋₁₈ alkyl, C₁₋₁₈ alkylene-S—C₁₋₁₈ alkyl, aryl, or substituted aryl groups, or a salt thereof; 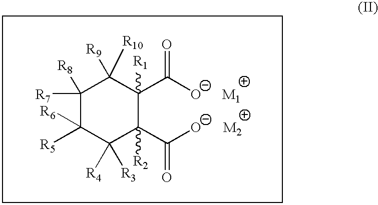
wherein M₁ and M₂ are the same or different and are selected from at least one metal cation of calcium, strontium, lithium, and monobasic aluminum, and wherein R₁, R₂, R₃, R₄, R₅, R₆, R₇, R₈, R₉, and R₁₀ are either the same or different and are individually selected from the group consisting of hydrogen, C₁-C₉ alkyl [wherein any two vicinal (neighboring) or geminal (same carbon) alkyl groups may be combined to form a carbocyclic ring of up to six carbon atoms], hydroxy, C₁-C₉ alkoxy, C₁-C₉ alkyleneoxy, amine, and C₁-C₉ alkylamine, halogens (fluorine, chlorine, bromine, and iodine), and phenyl. The term “monobasic aluminum” is well known and is intended to encompass an aluminum hydroxide group as a single cation bonded with the two carboxylic acid moieties. Furthermore, form each of these potential salts, the stereochemistry at the asymmetric carbon atoms may be cis or trans, although cis is preferred.

Particularly, though not necessarily preferred, nucleators are saturated types conforming to Formula (III) [related to Formula (I), above] 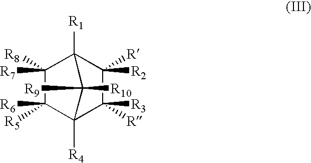
wherein R₁, R₂, R₃, R₄, R₅, R₆, R₇, R₈, R₉, and R₁₀ are individually selected from the group consisting of hydrogen, C₁-C₉ alkyl, hydroxy, C₁-C₉ alkoxy, C₁-C₉ alkyleneoxy, amine, and C₁-C₉ alkylamine, halogen, phenyl, alkylphenyl, and geminal or vicinal carbocyclic having up to 9 carbon atoms, R′ and R″ are the same or different and are individually selected from the group consisting of hydrogen, C₁-C₃₀ alkyl, hydroxy, amine, polyamine, polyoxyamine, C₁-C₃₀ alkylamine, phenyl, halogen, C₁-C₃₀ alkoxy, C₁-C₃₀ polyoxyalkyl, C(O)—NR₁₁C(O), and C(O)O—R′″, wherein R₁₁ is selected from the group consisting of C₁-C₃₀ alkyl, hydrogen, C₁-C₃₀ alkoxy, and C₁-C₃₀ polyoxyalkyl, and wherein R′″ is selected from the group consisting of hydrogen, a metal ion (such as, without limitation, Na⁺, K⁺, Li⁺, Ag⁺ and any other monovalent ions), an organic cation (such as ammonium as one non-limiting example), polyoxy-C₂-C₁₈-alkylene, C₁-C₃₀ alkyl, C₁-C₃₀ alkylene, C₁-C₃₀ alkyleneoxy, a steroid moiety (for example, cholesterol), phenyl, polyphenyl, C₁-C₃₀ alkylhalide, and C₁-C₃₀ alkylamine; wherein at least one of R′ and R″ is either C(O)—NR₁ ₁C(O) or C(O)O—R′″, wherein if both R′ and R″ are C(O)O—R′″ then R′″ both R′ and R″ may be combined into a single bivalent metal ion (such as Ca²⁺, as one non-limiting example) or a single trivalent metal overbase (such as Al-OH, for one non-limiting example). Preferably, R′ and R″ are the same and R′″ is either Na⁺ or combined together for both R′ and R″ and Ca²⁺. Other possible compounds are discussed in the preferred embodiment section below.

Preferably, such a compound conforms to the structure of Formula (IV) 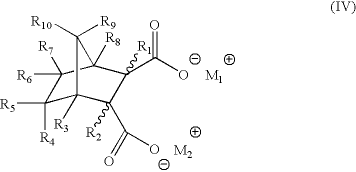
wherein M₁ and M₂ are the same or different and are independently selected from the group consisting of metal or organic cations or the two metal ions are unified into a single metal ion (bivalent, for instance, such as calcium, for example), and R₁, R₂, R₃, R₄, R₅, R₆, R₇, R₈, R₉, and R₁₀ are individually selected from the group consisting of hydrogen, C₁-C₉ alkyl, hydroxy, C₁-C₉ alkoxy, C₁-C₉ alkyleneoxy, amine, and C₁-C₉ alkylamine, halogen, phenyl, alkylphenyl, and geminal or vicinal carbocyclic having up to 9 carbon atoms. Preferably, the metal cations are selected from the group consisting of calcium, strontium, barium, magnesium, aluminum, silver, sodium, lithium, rubidium, potassium, and the like. Within that scope, group I and group II metal ions are generally preferred. Among the group I and II cations, sodium, potassium, calcium and strontium are preferred, wherein sodium and calcium are most preferred. The disodium bicyclo[2.2.1]heptanedicarboxylate is most preferred for this purpose and is available under the tradename HPN-68 from Milliken & Company (hereinafter referred to as “HPN-68”). Furthermore, the M₁ and M₂ groups may also be combined to form a single metal cation (such as calcium, strontium, barium, magnesium, aluminum, including monobasic aluminum, and the like). Although this invention encompasses all stereochemical configurations of such compounds, the cis configuration is preferred wherein cis-endo is the most preferred embodiment. The preferred embodiment polyolefin articles and additive compositions for polyolefin formulations comprising at least one of such compounds, broadly stated as saturated bicyclic carboxylate salts, are also encompassed within this invention.

As noted above, the inventive articles are LDPE in nature, at least comprising a majority of such a polymer therein. Other possible polymeric or elastomeric constituents within the target articles may include, other polyolefins (such as polypropylene), polyacrylates, polyamides, polyesters, polybutene, polycarbonates, rubber particles, polyurethanes, and the like. Such formulations may be utilized in myriad different end-uses, including without limitation, such broadly considered groups as thin film or thin-walled articles (e.g., pliable wrappers, thin-walled drinking cups, etc., having thicknesses between 0.1 and 15 mils, for example), thicker plaque or other like solid articles (e.g., from 15 to 150 mils in thickness), and even thicker-walled articles (e.g., greater than 150 mils thickness), and still be accorded the benefits of low warpage and increased crystallization temperatures noted above.

Optional additives within the inventive LDPE articles may include, without limitation, plasticizers, antistatic agents, stabilizers, ultraviolet absorbers, and other similar standard polyolefin thermoplastic additives. Other additives may also be present within this composition, most notably plasticizers, acid scavengers, antimicrobials (preferably silver-based ion-exchange compounds, such as ALPHASAN® antimicrobials available from Milliken & Company), antioxidants, flame retardants, light stabilizers, antistatic agents, colorants, pigments, perfumes, chlorine scavengers, and the like.

The articles of the present invention may be obtained by adding the necessary nucleating additive (i.e., saturated or unsaturated bicyclic dicarboxylic salt, or cyclic dicarboxylate salt, or combination of salts thereof) to the LDPE-containing polymer or copolymer and merely mixing the resultant composition by any suitable means. Alternatively, a concentrate containing as much as about 20 percent by weight of the nucleating additive salt in a masterbatch comprising may be prepared and be subsequently mixed with the target resin. Furthermore, the inventive compositions (with other additives potentially) may be present within LDPE additive form, including, without limitation, powder, prill, agglomerate, liquid suspension, and the like, particularly comprising dispersion aids such as polyethylene waxes, stearate esters of glycerin, montan waxes, mineral oil, and the like. Basically, such a combination or composition may be provided in any form, including combinations made from blending, agglomeration, compaction, and/or extrusion.

The composition may then be processed and fabricated by any number of different techniques, including, without limitation, injection molding, injection blow molding, injection stretch blow molding, rotational molding, extrusion, extrusion blow molding, sheet extrusion, film extrusion, cast film extrusion, foam extrusion, thermoforming, blown-films (such as, as one non-limiting example, biaxially oriented films), thin wall injection molding, and the like, into a fabricated article.

### PREFERRED EMBODIMENTS OF THE INVENTION

This invention can be further elucidated through the following examples where examples of particularly preferred embodiment within the scope of the present invention are presented.

Production of Inventive Salts

### EXAMPLE 1

### Disodium Bicyclo[2.2.1]heptane-2,3-dicarboxylate

To a solution of disodium bicyclo[2.2.1]hept-5-ene-2,3-dicarboxylate (10.0 g, from example 3) in water (100 g) was added 0.5 g palladium on activated carbon (5 wt %). The mixture was transferred into a Parr reactor and was subjected to hydrogenation (50 psi, room temperature) for 8 hours. The activated carbon was filtered out, and the water was removed in vacuo at 75° C. The resulting product was dried and milled (m.p>300° C.). NMR and IR analyses were consistent with that of the expected structure. This product is commercially available from Milliken Chemical under the trade name Hyperfomm HPN-68.

### EXAMPLE 2

### Calcium Bicyclo[2.2.1]heptane-2,3-dicarboxylate

To a solution of disodium bicyclo[2.2.1]heptane-2,3-dicarboxylate (22.6 g, 0.1 mols) in water (150 g) was added a solution of calcium chloride dihydrate (14.7 g, 0.1 mols) in water (100 g). The mixture was stirred at 60° C. for 2 hours. The resulting white precipitate was filtered. The white powdery product was dried and milled (m.p. >300° C.).

### EXAMPLE 3

### Disodium bicyclo[2.2.1]hept-5-ene-2,3-dicarboxylate

To a suspension of endo-bicyclo[2.2.1]hept-5-ene-2,3-dicarboxylic anhydride (16.4 g, 0.1 mols) in water (100 g) was added sodium hydroxide (8.0 g, 0.2 mols) at room temperature. The mixture was then stirred at 80° C. for 2 hours. A clear, homogeneous solution was obtained. Water was removed in vacuum at 75° C. and the resulting white crystalline product was dried and milled (m.p. >300° C.).

Other Group I and II salts, lithium, potassium, rubidium, magnesium, strontium, and barium salts of bicyclo[2.2.1]heptane dicarboxylate and bicyclo[2.2.1]hept-5-ene-2,3 dicarboxylate salts were synthesized through similar procedures.

### EXAMPLE 4

### Cis-Disodium Hexahydrophthalate Salts

To a 250-mL Erlenmeyer flask with a magnetic stirrer was added water (100 mL), sodium hydroxide (10.38 g, 260 mmol), and cis-hexahydrophthalic anhydride (20 g, 130 mmol). The reaction mixture was stirred at room temperature until homogeneous, at which time a slight exotherm was observed. After stirring for three hours, the solution was poured into acetone (2 L), and the white solid collected via suction filtration. Drying in a vacuum oven at 110° C. gave 20.9 g (74%) as a white powder, mp>350° C. IR and NMR analysis were consistent with that of the expected product.

### EXAMPLE 5

### Cis-Calcium Hexahydrophthalate

To an 8-L cylindrical kettle fitted with a mechanical paddle stirrer and thermometer was added water (4 L) and calcium hydroxide (481 g, 6.49 moles) with stirring at room temperature. To this slurry was added cis-hexahydrophthalic anhydride (1 kg, 6.49 moles) and the slurry was heated to 50° C. After stirring with heat for 5 hours, the mixture became quite thick, at which time the pH of the aqueous phase was found to be about 7. The white product was collected by suction filtration, washed with copious amounts of water, and dried in a vacuum oven overnight at 140° C. The dry weight was 1270 grams (93% yield) having a melting point greater than about 400° C. The IR and NMR spectra were consistent with the expected product.

### EXAMPLE 6

### Cis-Dilithium Hexahydrophthalate

To a 1-L 3-necked round bottom flask fitted with a reflux condenser, mechanical stirrer, and thermometer was added water (300 mL), lithium hydroxide monohydrate (17.7 g, 421 mmol), and cis-hexahydrophthalic anhydride (30.8 g, 200 mmol). After heating at reflux for 3 hours, the reaction mixture was cooled and then poured into acetone (500 mL). No precipitate formed, and the solvents were removed by rotary evaporation to give a white powder. The powder was washed on a filter with 50 mL of cold water, and the solid was dried in a vacuum oven at 85° C. overnight. The dry weight as about 37 grams (100%), with a melting point greater than about 350° C. IR and NMR analysis were consistent with that of the expected product.

Other comparative examples of commercial samples of Millad® 3988 (“DMDBS”), sodium benzoate, NA-11, and NA-21 were used in this evaluation as well.

Nucleation Efficacy Test Example 1:

Thermoplastic compositions (plaques) were produced comprising the additives from the Examples above and sample LDPE resin plaques, produced dry blended in a Welex mixer at ˜2000 rpm, extruded through a single screw extruder at 325-375° F., and pelletized. Accordingly, one kilogram batches of target LDPE were produced in accordance with the following table:

TABLE 1
LOW DENSITY POLYETHYLENE COMPOSITION

| Component | Amount |
|---|---|
| Dowlex ® 2517 Low Density Polyethylene (with | 1000 g |
| Antioxidants and Acid scavengers already supplied) | |
| Nucleator | as noted |

The base LDPE and all additives were weighed and then blended in a Welex mixer for 1 minute at about 1600 rpm. All samples were then melt compounded on a Killion single screw extruder at a ramped temperature from about 325-375° F. (˜163-191° C.) through four heating zones. The melt temperature upon exit of the extruder die was about 375° F. (˜191° C.). The screw had a diameter of 1.5 inches (˜3.81 cm) and a length/diameter ratio of 24:1. The molder was set at a temperature anywhere between 180 and 260° C., with a range of 190 to 240° C. preferred, most preferably about 200° C., from which sample disks were produced. The disks had dimensions of about 6 inches diameter and about 80 mils thickness, and the mold had a mirror finish that was transferred to the individual disks. The mold cooling circulating water was controlled at a temperature of about 50° F. (˜10°).

Testing for nucleating effects and other important criteria were accomplished through the formation of disks of target LDPE thermoplastic resin. These disks were formed through the process outlined above with the specific compositions listed above in the above Table.

These disk formulations are, of course, merely preferred embodiments of the inventive article and method and are not intended to limit the scope of this invention. The resultant disks were then tested for peak crystallization temperatures (by Differential Scanning Calorimetry). Crystallization is important in order to determine the time needed to form a solid article from the molten polyolefin composition. Generally, a polyolefin such as LDPE has a crystallization temperature of about 100° C. at a cooling rate of 20° C./min. In order to reduce the amount of time needed to form the final product, as well as to provide the most effective nucleation for the polyolefin, the best nucleator compound added will invariably also provide the highest crystallization temperature for the final LDPE product. The nucleation composition efficacy, particular polymer peak crystallization temperature (Tc), was evaluated by using DSC according to ASTM D-794-85. To measure these temperatures, the specific polypropylene composition was heated from 60° C. to 220° C. at a rate of 20° C. per minute to produce a molten formulation and held at the peak temperature for 2 minutes. At that time, the temperature was then lowered at a rate of 20° C. per minute until it reached the starting temperature of 60° C. The crystallization temperature was thus measured as the peak maximum during the crystallization exotherm.

The following Table lists the peak crystallization temperatures for the plaques prepared above:

EXPERIMENTAL TABLE 1
Performance of Nucleating Additives in LDPE

| | | Polym. Cryst. Temp |
|---|---|---|
| Additives | Additive Conc. (%) | (° C.) |
| Control | None | 99.8 |
| Example 1 | 0.075 (750 ppm) | 107.1 |
| Example 1 | 0.15 (1500 ppm) | 107.8 |
| Example 3 | 0.15 (1500 ppm) | 102.8 |
| DMDBS | 0.2 (2000 ppm) | 109.1 |

Thus, HPN-68, Example 1, imparts excellent high crystallization temperatures well above the control LDPE sample, and the unsaturated version provides a higher crystallization temperature than the polyethylene alone.

Nucleation Efficacy Test Examples

Thermoplastic compositions (plaques) were produced comprising the additives from the Examples above and sample LDPE resin plaques, produced dry blended in a Welex mixer at ˜2000 rpm, extruded through a single screw extruder at 325-375° F., and pelletized. Accordingly, one kilogram batches of target LDPE were produced in accordance with the following table:

TABLE 2
LOW DENSITY POLYETHYLENE COMPOSITION

| Component | Amount |
|---|---|
| Dowlex ® 2045 Low Density Polyethylene (with | 1000 g |
| Antioxidants and Acid scavengers already supplied) | |
| Nucleator | as noted |

The sample was prepared and analyzed using the same procedure of example 1.

The following Table lists the peak crystallization temperatures for the plaques prepared above:

EXPERIMENTAL TABLE 2
Performance of Nucleating Additives in LDPE

| | | Polym. Cryst. |
|---|---|---|
| Additives | Additive Conc. (%) | Temp (° C.) |
| Control | None | 100.2 |
| DMDBS | 0.2 (2000 ppm) | 104.6 |
| Example 1 | 0.1 (1000 ppm) | 104.6 |
| Example 2 | 0.1 (1000 ppm) | 104.3 |
| Barium bicyclo[2.2.1]heptane- | 0.1 (1000 ppm) | 104.6 |
| 2,3-dicarboxylate | | |
| Strontium bicyclo[2.2.1]heptane- | 0.1 (1000 ppm) | 102.9 |
| 2,3-dicarboxylate | | |
| Potassium bicyclo[2.2.1]heptane- | 0.1 (1000 ppm) | 103.9 |
| 2,3-dicarboxylate | | |
| Example 3 | 0.1 (1000 ppm) | 102.9 |
| Barium bicyclo[2.2.1]hept-5-ene- | 0.1 (1000 ppm) | 103.2 |
| 2,3-dicarboxylate | | |
| Example 4 | 0.1 (1000 ppm) | 103.6 |
| Example 5 | 0.1 (1000 ppm) | 104.3 |
| Example 6 | 0.1 (1000 ppm) | 104.3 |

Thus, these inventive nucleators impart significantly higher crystallization temperatures well above the control LDPE sample and very similar to that of DMDBS.

Warage Testing

For such test procedures, discs, rather than plaques, having the dimensions of 80 mils thickness and 6 inches diameter, were utilized: Two different methods were followed: first utilizing handheld and manipulated calipers, and subsequently utilizing mechanically measured pressure-sensor instruments. In essence, both procedures involved measuring the height of the target discs from the bottom side to the highest point at which the top side extends therefrom. With handheld calipers, the measurement was made empirically by measuring the distance from the bottom of the disc to the highest point at which a lowered caliper touches the disc through human operation and detection. The pressure-sensor protocol permitted a repeatable test to determine the total deflection (a/k/a extent of warpage) of the injection-molded parts from a standard thickness measurement. In such an analysis, a computer-controlled device lowered a metal platen connected to a load cell until a constant force was applied and detected. Thus, upon load cell detection of a 0.1 N force, the computer-controlled device stopped further lowering of the metal platen and the distance between the movable metal platen and the zero (bottom) position of the sample disc was then measured electronically. The amount of platen separation (height of the metal platen less the zero position of the sample disc) was equal to the measured thickness (total deflection) of the injection-molded part (a perfect measurement would be 80 mil; all other measurements would be greater than such a standard measurement as warpage caused thickness increases). Thus, the target disc was placed in a proper holding device and the load cell-bearing weight was lowered (at a speed of 0.20 inches/min) until the aforementioned 0.1 N pressure was detected at the highest point of the target disc (the instrument utilized for such a procedure was an MTS Qtest/5 Elite Controller). The highest point of recorded height or pressure therefore indicated the warpage present within the target disc. The term “warpage test” is thus intended to encompass such a test for the purposes of defining this invention.

The above procedures were undertaken subsequent to disc production, de-molding, stacking, and cooling to room temperature. After cooling for roughly 24 hours, warpage was quantified as noted above. The unnucleated control sample showed a large increase in total deflection, while the inventive HPN-68 sample remained essentially flat in comparison. Quantitatively, the inventive sample discs restricted warpage increase to 35%, and the control resin increased warpage by roughly 121% over the same 37% reduction in cycle time (from 6 seconds to 0 seconds cooling time). The results were as follows (with % warpage measured as the mean sample height less the 80 mils standard divided by 80 mils all multiplied by 100)(Measured Thickness is the aggregate distance from the bottom of the sample disc to the highest point at which 0.1 N of pressure is detected upon lowering of the aforementioned load cell):

EXPERIMENTAL TABLE 3
Warpage of 80-mil discs

| | | Measured | |
|---|---|---|---|
| | Cooling | Thickness | |
| Sample | Time (sec) | (avg in mils) | % Warpage |
| Example 1 | 0 | 118.721 | 48.4 |
| ″ | 1 | 93.701 | 17.1 |
| ″ | 2 | 92.84 | 16.1 |
| ″ | 3 | 88.87 | 11.1 |
| ″ | 4 | 89.36 | 11.7 |
| ″ | 5 | 91.31 | 14.1 |
| ″ | 6 | 90.44 | 13.1 |
| (Comparatives) | | | |
| Control | 0 | 192.8 | 141 |
| ″ | 1 | 114.1 | 42.6 |
| ″ | 2 | 93.9 | 17.4 |
| ″ | 3 | 93.0 | 16.2 |
| ″ | 4 | 93.3 | 16.6 |
| ″ | 5 | 93.2 | 16.5 |
| ″ | 6 | 95.8 | 19.8 |

The sample showed a large increase in warpage difference (141-19.8 ˜121%) while the inventive sample exhibited the aforementioned reduced level (48.4-13.1 ˜35%). With handheld calipers, the quantitative measurements were essentially the same (with stack-cooled sample articles), with the inventive sample resin reducing the total deflection of the 80-mil discs by roughly 25% over the 37% reduction in cycle time.

Other sample discs were then prepared, in addition to new control and HPN-68 types (including different levels of HPN-68 samples, 750 and 1500 ppm), and Example 2, a/k/a unsaturated HPN-68, comparative measurements were made for DMDBS, NA-11, and NA-21. The inventive resins were able to control warpage, while all other additives seemed to increase the warpage of the target LDPE discs. Furthermore, there appears to be no difference in warpage reduction between the two different levels of the Example 1 resin additive. The following measurements are the averages of three different discs for each sample resin taken via the aforementioned pressure-sensor measurement procedure.

EXPERIMENTAL TABLE 4
Warpage Measurements of 80-mil discs Over
6-Second Spans of Cooling Times

| | Amount | | Thickness | |
|---|---|---|---|---|
| Sample | (ppm) | Cool Time (sec) | (avg)(mils) | % Warpage |
| Example 1 | 1500 | 0 | 101.25 | 26.6 |
| ″ | ″ | 2 | 90.65 | 13.3 |
| ″ | ″ | 4 | 93.72 | 17.2 |
| ″ | ″ | 6 | 92.27 | 15.3 |
| Example 1 | 750 | 0 | 115.12 | 43.9 |
| ″ | ″ | 2 | 90.34 | 12.9 |
| ″ | ″ | 4 | 92.84 | 16.1 |
| ″ | ″ | 6 | 90.03 | 12.5 |
| Example 2 | 1500 | 0 | 98.82 | 23.5 |
| ″ | ″ | 2 | 93.7 | 17.1 |
| ″ | ″ | 4 | 89.84 | 12.4 |
| ″ | ″ | 6 | 91.83 | 14.8 |
| (Comparatives) | | | | |
| Control | — | 0 | 276.81 | 246 |
| ″ | ″ | 2 | 92.84 | 16.1 |
| ″ | ″ | 4 | 97.13 | 21.41 |
| ″ | ″ | 6 | 100.68 | 25.9 |
| DMDBS | 2000 | 0 | 575.68 | 620 |
| ″ | ″ | 2 | 510.91 | 539 |
| ″ | ″ | 4 | 487.22 | 509 |
| ″ | ″ | 6 | 435.44 | 444 |
| NA-11 | 1000 | 0 | 439.72 | 450 |
| ″ | ″ | 2 | 378.00 | 373 |
| ″ | ″ | 4 | 363.16 | 354 |
| ″ | ″ | 6 | 291.99 | 265 |
| NA-21 | 1000 | 0 | 462.32 | 478 |
| ″ | ″ | 2 | 417.43 | 422 |
| ″ | ″ | 4 | 403.28 | 404 |
| ″ | ″ | 6 | 338.41 | 323 |

The comparative nucleated LDPE articles exhibited a significant increase in warpage as the cooling time was reduced from 6.0 to 0.0 seconds in the control resin (37% cycle time reduction). The inventive articles, however, exhibited minimal increases in warpage over the same cooling time (cycle time reduction) range, but overall decrease in warpage of enormous levels as a function of reduced cooling time. Overall, the inventive articles exhibited reduced warpage by ˜105% at the 0.0 second cooling time.

Having described the invention in detail it is obvious that one skilled in the art will be able to make variations and modifications thereto without departing from the scope of the present invention. Accordingly, the scope of the present invention should be determined only by the claims appended hereto.

1. A low-warpage low density polyethylene article, wherein said article comprises at least one nucleating additive and exhibits a crystallization temperature greater than the crystallization temperature exhibited by the same article free from any nucleator compound, wherein said article exhibits a warpage percentage under a warpage test of at most 35%, and wherein said article is produced in such a manner that the cooling time after article formation is at most 1 second at a maximum cooling temperature of 50° F. (˜10° C.).

2. The article of claim 1 wherein said nucleating additive conforms to the structure of either of Formula (1) or (II) 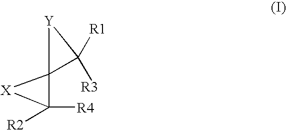
wherein X and Y are independently C₁₋₁₈ alkylene, C₂₋₁₈ alkenylene, C₃₋₁₈ cycloalkylene, C₄₋₁₈ cycloalkenylene, or arylene; wherein R₁ and R₂ are independently H, C₁₋₁₈ alkyl, or COR₅; wherein R₃ and R₄ together form -A-B-C, wherein A and C are independently a ketone, —O—, —CR₆R₇—, or —CR₆—; and wherein B is a single or double bond, or when neither A nor C is —O—, B can be —O—; R₅ is —OH, —O-C₁₋₁₈ alkyl, —O-aryl, or —NRR′; each R₆ and R₇ is independently —H, halogen, C₁₋₁₈ alkyl, C₃₋₁₈ cycloalkyl, —COR₅, —CRR′-COR₅, or NRR′; each R and R′ is independently —H, C₁₋₁₈ alkyl, C₃₋₁₈ cycloalkyl, or C₁₋₁₈ alkyl substituted by one or more —OH, halogen, —COOH, COOC₁₋₁₈ alkyl, C₁₋₁₈ alkylene-S-C-₁₋₁₈ alkyl, aryl, or substituted aryl groups, or a salt thereof; 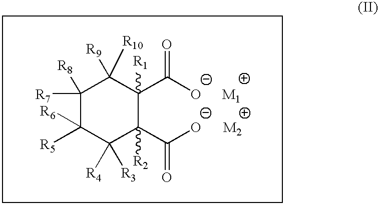
wherein M₁ and M₂ are the same or different and are selected from at least one metal cation of calcium, strontium, lithium, and monobasic aluminum, and wherein R₁, R₂, R₃, R₄, R₅, R₆, R₇, R₈, R₉, and R₁₀ are either the same or different and are individually selected from the group consisting of hydrogen, C₁-C₉ alkyl, wherein any two vicinal or geminal alkyl groups may be combined to form a carbocyclic ring of up to six carbon atoms, hydroxy, C₁-C₉ alkoxy, C₁-C₉ alkyleneoxy, amine, and C₁-C₉ alkylamine, halogens, and phenyl.

3. The article of claim 2 wherein said nucleating additive is a saturated bicyclic dicarboxylate salt conforming to the structure of Formula (III) 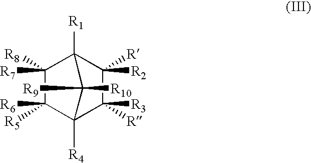
wherein R₁, R₂, R₃, R₄, R₅, R₆, R₇, R₈, R₉, and R₁₀ are individually selected from the group consisting of hydrogen, C₁-C₉ alkyl, hydroxy, C₁-C₉ alkoxy, C₁-C₉ alkyleneoxy, amine, and C₁-C₉ alkylamine, halogen, phenyl, alkylphenyl, and geminal or vicinal carbocyclic having up to 9 carbon atoms, R′ and R″ are the same or different and are individually selected from the group consisting of hydrogen, C₁-C₃₀ alkyl, hydroxy, amine, polyamine, polyoxyamine, C₁-C₃₀ alkylamine, phenyl, halogen, C₁-C₃₀ alkoxy, C₁-C₃₀ polyoxyalkyl, C(O)—NR₁₁C(O), and C(O)O—R′″, wherein R₁ ₁ is selected from the group consisting of C₁-C₃₀ alkyl, hydrogen, C₁-C₃₀ alkoxy, and C₁-C₃₀ polyoxyalkyl, and wherein R′″ is selected from the group consisting of hydrogen, a metal ion, an organic cation, polyoxy-C₂-C₁₈-alkylene, C₁-C₃₀ alkyl, C₁-C₃₀ alkylene, C₁-C₃₀ alkyleneoxy, a steroid moiety, phenyl, polyphenyl, C₁-C₃₀ alkylhalide, and C₁-C₃₀ alkylamine; wherein at least one of R′ and R″ is either C(O)—NR₁₁C(O) or C(O)O—R′″, wherein if both R′ and R″ are C(O)O—R′″ then R′″ both R′ and R″ may be combined into a single bivalent metal ion or a single trivalent metal overbase.

4. The article of claim 3 wherein said compound conforms to the 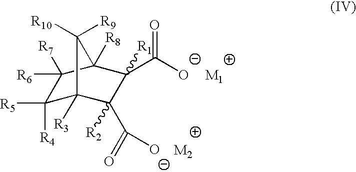
wherein M₁ and M₂ are the same or different and are independently selected from the group consisting of metal or organic cations, or M₁ and M₂ are combined to from a single moiety, and R₁, R₂, R₃, R₄, R₅, R₆, R₇, R₈, R₉, and R₁₀ are individually selected from the group consisting of hydrogen, C₁-C₉ alkyl, hydroxy, C₁-C₉ alkoxy, C₁-C₉ alkyleneoxy, amine, C₁-C₉ alkylamine, halogen, phenyl, alkylphenyl, and geminal or vicinal C₁-C₉ carbocyclic.

5. The article of claim 3 wherein said metal or organic cation on said compound is a metal cation selected from the group consisting of Group I and Group II metal ions.

6. The article of claim 5 wherein said metal cation on said compound is selected from the group consisting of sodium, potassium, calcium, lithium, rubidium, barium, magnesium, strontium, silver, zinc, and aluminum.

7. The article of claim 6 wherein said metal cation is sodium.

8. The article of claim 4 wherein said metal or organic cation on said compound is a metal cation selected from the group consisting of Group I and Group II metal ions.

9. The article of claim 8 wherein said metal cation on said compound is selected from the group consisting of sodium, potassium, calcium, lithium, rubidium, barium, magnesium, strontium, silver, zinc, and aluminum.

10. The article of claim 9 wherein said metal cation is sodium.
